(19) United States
(12) Patent Application Publication
(10) Pub. No.: US 2015/0336621 A1
(43) Pub. Date: Nov. 26, 2015

(54) Profile With U-Shaped Portion(S), Load-Bearing Structural Element Of A Vehicle Incorporating Same, And Method For Manufacturing The Profile

(71) Applicant: HUTCHINSON, Paris (FR)

(72) Inventors: Michaël Godon, Neuvy-deux Clochers (FR); Stéphane Bergere, Saint Jean Le Blanc (FR); Bertrand Florentz, Paucourt (FR); Jean-Pierre Ciolczyk, Montargis (FR)

(21) Appl. No.: 14/650,650

(22) PCT Filed: Dec. 10, 2013
(86) PCT No.: PCT/IB2013/060772

§ 371 Date: Jun. 9, 2015

(30) Foreign Application Priority Data
Dec. 10, 2012 (FR) 12 61826

(51) Int. Cl. B62D 29/04; E04C 3/29; B29C 65/70; B64C 1/06

(52) U.S. Cl. CPC B62D 29/04; B64C 1/06; E04C 3/29; B29C 65/70

(57) ABSTRACT

A profile with one or more portion(s) whose cross-sections are substantially U-shaped, locally provided with capabilities of increasing torsional rigidity and potentially flexural rigidity, a load-bearing structural element of a vehicle such as a support grille of an electrical and/or hydraulic system incorporating that profile, and a method of manufacturing that profile are provided. The profile includes at least one U-shaped portion having a slot bounded by two wings and a core and that is locally provided and capable for increasing torsional rigidity, the profile being formed of a fibre-reinforced plastic composite, having at least one cross brace formed in the slot from a single part with the wings and the core. The wings and the core are reinforced by fibres mostly oriented in the longitudinal direction of the profile, with more than 60% of the fibres oriented in a −30° to +30° angle with that direction.

The present invention relates to a profile with substantially U-shaped portion(s) which are locally provided with means improving torsional and possibly flexural stiffness, to a load-bearing structural element of a vehicle incorporating this profile, and to a method of manufacturing this profile. The invention applies to such a plastic composite profile for a load-bearing structural element of any type of vehicle requiring to be lightened for energy-saving purposes or to improve its performance, particularly for an aircraft aerostructure (e.g. floor supports, fuselage stringers, suction face or pressure face stiffeners in the wings), for a self-supporting motor vehicle chassis or the like comprising structural stiffeners (e.g. longitudinal members, crossmembers, transverse members, reinforcers, connecting rods) or for a grating for supporting an electrical and/or hydraulic system, notably in the aeronautical, automotive, naval, rail domains or building.

In aircraft and spacecraft it is known practice to attach wiring harnesses and/or fluid transfer circuits to a grating the crossmembers of which comprise metallic or non-metallic profiles typically made of a composite material having a thermoplastic matrix. In general, these profiles need to have local or overall flexibility in torsion and in building and need to be stiffened in order to meet the robustness requirements of the gratings in which they are incorporated while at the same time maintaining a satisfactory compromise between the mass and stiffness obtained.

These composite profiles for such support gratings are usually made up of a multitude of layers or plies of thermoplastic matrix reinforced with carbon and glass fabric, and these are stiffened for example by adding additional plies oriented in the direction seen to be flexible.

One major disadvantage with these profiles stiffened in this way lies in the considerable increase in the thickness and therefore mass thereof, something which penalizes the aforementioned compromise between mass and stiffness.

One object of the present invention is to propose a profile comprising at least one portion of substantially U-shaped cross section which has a channel delimited by two sidewalls and a base connecting them together and which is locally provided with means able to stiffen it in torsion, the profile being made up of a fiber-reinforced plastic composite, these means of local stiffening comprising at least one cross brace formed in this channel of one piece with the sidewalls and this base, which overcomes these disadvantages by proposing an innovative separation of the functions notably making it possible to make this profile lighter.

To this end, a profile according to the invention is such that said sidewalls and said base are reinforced with fibers oriented predominantly in the longitudinal direction of the profile, with over 60% of these fibers being oriented in a direction that makes an angle of between −30° and +30° with said longitudinal direction (i.e. with the axial direction of said U-shaped portion which may coincide with the axis of the profile).

It will be noted that these means that provide stiffening at least in torsion according to the invention require only a local addition of material, making it possible for the profile to maintain a low mass.

According to another feature of the invention, said at least one cross brace may comprise at least two ribs providing torsional stiffening, which extend in planes substantially perpendicular to the plane of said base over substantially the entire height of said channel.

According to one advantageous embodiment of the invention, said ribs have a mutual intersection at a middle zone of said at least one cross brace which brace is substantially X-shaped with the tips secured to said sidewalls, with a view to locally increasing the torsional stiffness of the profile as mentioned hereinabove.

Advantageously, said at least one portion may have a plurality of said cross braces spaced apart longitudinally and also able to stiffen this portion in flexion, these cross braces not being connected to one another. In other words, these cross braces which succeed on another without being in any way joined together are able to increase predominantly the torsional but also the flexural stiffness of the profile.

It will be noted that these cross braces are preferably situated at zones of the profile that exhibit high torsional and/or flexural (i.e. bending) flexibility.

According to another preferred feature of the invention, said profile is made up of said composite which has a thermoplastic matrix, said at least one cross brace being formed of one piece with said at least one portion by overmolding, for example by two-shot injection molding, compression molding, or bulk molding, welding or bonding, by way of nonlimiting example (it being emphasized that other techniques for making the cross brace(s) secured as one piece to the profile may be used).

It will be noted that this (these) cross brace(s) according to the invention may or may not be filled with reinforcers.

For preference, said at least one portion is made up of a first composite with a thermoplastic matrix, said at least one cross brace being overmolded onto this portion and made up of a second composite with a thermoplastic matrix chemically compatible with the matrix of the first composite, these matrices preferably being chosen from the group consisting of polyphenylene sulfides (PPS), polyether ether ketones (PEEK), polyether ketone ketones (PEKK), polyamides (PA), polyether imides (PEI) and blends thereof.

Advantageously, said first composite is reinforced with said fibers which are oriented predominantly in the longitudinal direction of the profile and which are continuous fibers of alternatively long fibers (typically of several centimeters in length), so as to increase the flexural rigidity of the profile while minimizing the mass thereof.

More preferably still:
said first composite comprises a stack of sheets preimpregnated with said thermoplastic matrix and reinforced with carbon fabrics, this stack ending at an internal surface of said channel with a sheet based on this same matrix and filled with glass fabric(s), and
said second composite is reinforced with glass or carbon fibers, preferably short glass or carbon fibers.

Advantageously, said second composite, which is overmolded onto said at least one portion may furthermore by this overmolding cover the longitudinal and/or transverse edges or borders of the profile so as to conceal the fibers visible on these edges.

It will be noted that without this covering and resultant concealment of the fibers, subsequent treatments to afford protection against moisture would be needed, something that the present invention thus avoids.

According to another feature of the invention, said profile may be made up of a single said substantially U-shaped portion said sidewalls of which end substantially at right angles in two respective flanges extending away from one another, these flanges being provided with means, such as brackets, of attachment to a support accepting this profile, so that this support and the profile sitting atop it form a crossmember of a grating able to support a fluid circuit and/or a wiring harness.

Advantageously, said means of attachment may comprise pairs of brackets extending opposite each other from said flanges, the two brackets of each of said pairs being joined together by a transverse web, preferably overmolded, which stiffens these brackets.

More advantageously still, at least one of these transverse stiffening webs supports a clamp for attaching a member such as a pipe or a strand of cables, this clamp preferably being overmolded as one piece with the web that supports it.

Advantageously also, said second composite which is overmolded over said at least one portion may also through this overmolding form support zones such as bosses under said means of attachment of the profile, these support zones being able to hold the profile on another similar component.

It will be noted that this material thus overmolded on the external surface of the profile advantageously allows the weight and overall cost of manufacture of the component to be reduced significantly.

A load-bearing structural element of a vehicle according to the invention, this element being for example as explained above a longitudinal member, a crossmember, a structural stiffener or a grating able to support a fluid circuit and/or a wiring harness (particularly in an aircraft, spacecraft or land vehicle) and comprising longitudinal members and crossmembers, is characterized in that it comprises this profile as defined hereinabove preferably in conjunction with said thermoplastic matrix composite materials for said at least one substantially U-shaped portion.

A method of manufacturing, according to the invention, a profile as defined hereinabove involves securing said at least one cross brace to said at least one substantially U-shaped portion by overmolding, molding, welding or bonding.

Advantageously, in the preferred case in which this profile is made of thermoplastic or composite material(s) with a thermoplastic matrix, said at least one substantially U-shaped portion is fashioned by stamping or by compression molding, and said at least one cross brace is secured to this portion by overmolding, for example by two-shot injection molding, by compression molding, or by bulk molding.

Further features, advantages and details of the present invention will become apparent from reading the following description of one exemplary embodiment of the invention given by way of nonlimiting illustration, this description being given with reference to the attached drawings among which:

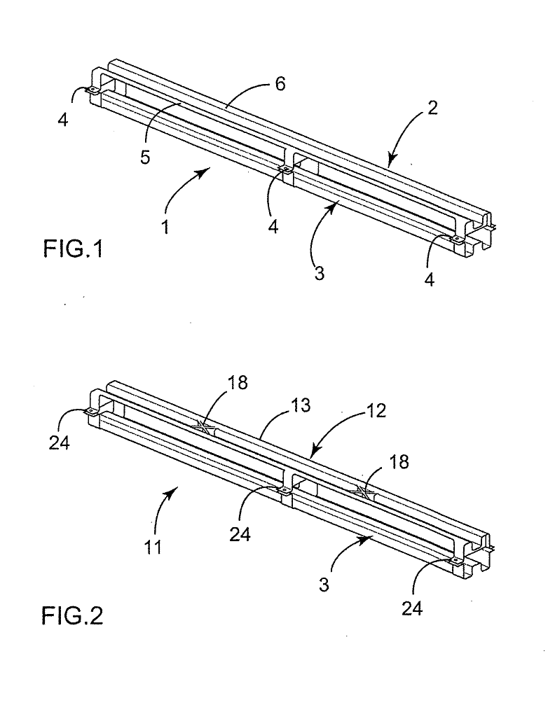

FIG. 1 is a schematic and perspective view from above of a grating crossmember according to the prior art which is intended to support a fluid circuit and a wiring harness of an aircraft and is made up of a profile fixed to a support,

FIG. 2 is a schematic and perspective view from above of a grating crossmember according to the invention, made up of a profile of the invention provided with stiffening cross braces and fixed to the support of FIG. 1,

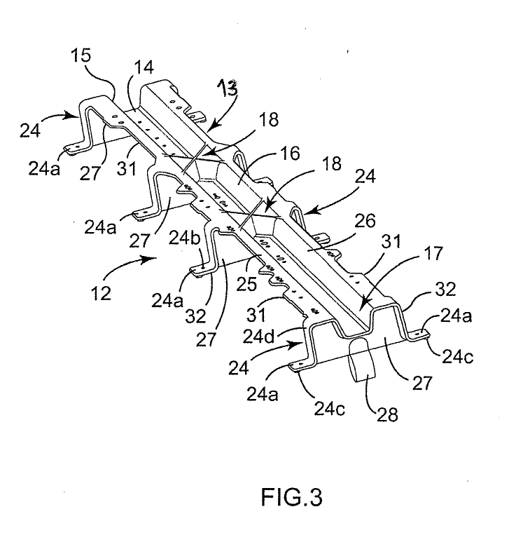

FIG. 3 is a perspective view from above on a larger scale of a profile of the invention of the kind included in the crossmember of FIG. 2,

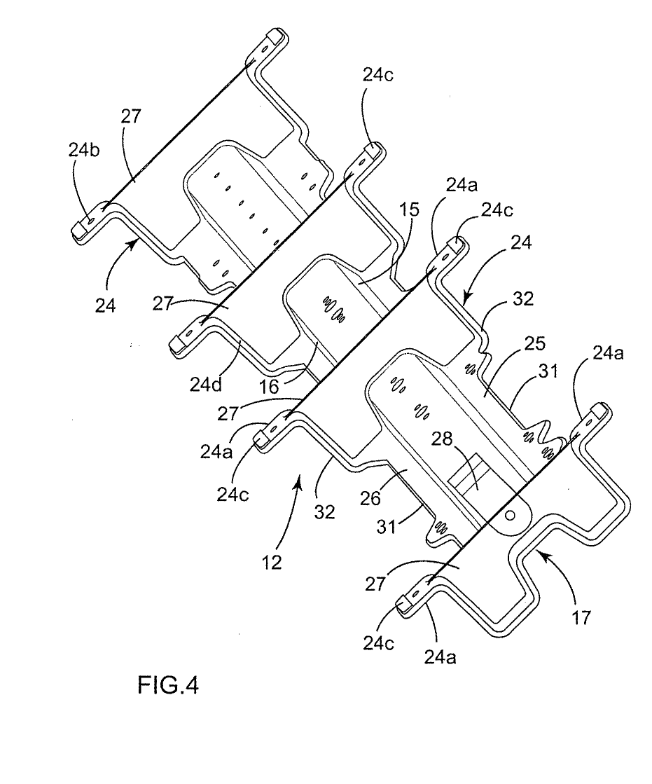

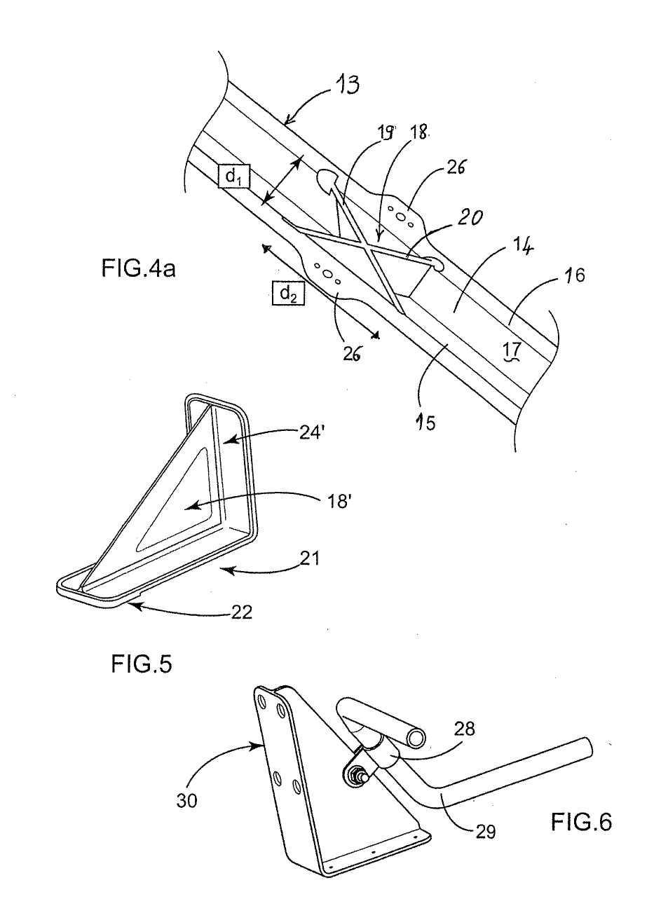

FIG. 4 is a perspective view from underneath of the profile of FIG. 3,

FIG. 4a is a perspective view from above illustrating in detail the location and structure of each stiffening cross brace of the profile of FIGS. 2 to 4,

FIG. 5 is a schematic and perspective view from above of an element of another profile according to the invention, and

FIG. 6 is a schematic and perspective view from above of another element of another profile according to the invention.

The crossmember 1 of the grating (or more generally of a bearing structure such as a stiffener) according to the prior art and illustrated in FIG. 1 is made up of a known profile 2 of U-shaped cross section made for example of a composite material with thermoplastic matrix and which is fixed to a lower support 3, of similar geometry, by attachment brackets 4 extending on each side of the two sidewalls 5 and 6 of the U as respective flanges of these sidewalls and which are joined for example by bolting to the support 3. The profile 2 is torsionally and flexurally stiffened by its intrinsic structure based on layers of thermoplastic composites reinforced by carbon and glass fabrics supplemented by oriented plies, which penalizes the mass of the profile 2.

The crossmember 11 with grating (or more generally of a load-bearing structural element such as a stiffener) according to the invention and illustrated in FIG. 2 differs from that of FIG. 1 through the structure and materials used for its profile 12, the support 3 in this example remaining unchanged.

The profile 12 illustrated in detail in FIGS. 3, 4 and 4a is, in this example, obtained by an overmolding of the U-shaped portion 13 of the profile (made from a first composite thermoplastic matrix) by injection overmolding in contact with the base 14 and sidewalls and 16 of the channel 17 of the U-section of a second composite with a thermoplastic matrix chemically compatible with that of the first composite so as to form several cross braces 18. The latter are thus longitudinally spaced apart along the channel 17 and formed of one piece therewith, and locally stiffen the profile 12 essentially in torsion (although partially also in flexion).

Only two cross braces 18 have been illustrated in the example of FIGS. 2 and 3, it being emphasized that a higher number of cross braces 18 and/or a different spacing between them, as well as possibly cross braces of different geometries along the channel 17 or even in an alternating or non-alternating series of cross braces 18 and of one or more stiffening ribs that do not form such cross braces 18 could be provided.

As visible in FIG. 4a, each of the cross braces 18 is formed of the intersection at an acute angle of ribs 19 and 20 perpendicular to the bottom 14 of the channel 17 and of a height equal to that of this channel, and may take the shape of a Saint Andrew's cross that has been flattened, i.e. having a transverse width d₁ equal to that of the channel 17 and distinctly less than its longitudinal dimension d₂. In other words, each cross brace 18 defines four dihedral angles in two identical pairs, of which two acute dihedral angles are open onto the channel 17 and two obtuse dihedral angles are closed by the sidewalls 15 and 16 at which they end. Solely by way of example, each cross brace 18 may have a length d₂ greater than three times its transverse width d₁, for example equal to four times the latter dimension (e.g. a width d₁ of 25 mm for a length d₂ of 100 mm).

By way of thermoplastic composite that can be used for the U-shaped portion 13 of the profile 12, it is possible for example to use a stack of sheets preimpregnated with PPS (or for example with PA in the automotive industry) the core of which is reinforced with carbon fabrics (for example containing a fiber content in excess of 50% by volume of carbon) and ending at an internal surface of the channel 17 with a ply of glass fabric reinforced PPS (for example containing 47.5% by volume of glass). This U-shaped portion 13 of the profile 12 is preferably produced by stamping or by compression molding.

By way of thermoplastic composite that can be used for each stiffening cross brace 18 injection overmolded in contact with this internal surface of the channel 17, it is possible for example to use a PPS (or for example PA in the automotive industry) filled to an extent substantially in excess of 40% by volume with short glass or carbon fibers, or in the other thermoplastic matrix identical to or compatible with that of the portion 13.

As visible in FIGS. 3 and 4, the sidewalls 15 and 16 of the profile 12 are extended at right angles by flanges 25 and 26 which at regular intervals and laterally facing one another are provided with pairs of brackets 24 (formed of L-shaped legs) for attachment to the support 3 of FIG. 2. The bottom leg 24a of the L that forms each bracket 24 is provided with an orifice 24b for attachment to the support 3 and, on the underside of this leg 24a, with an overmolded boss 24c defining a support zone for resting on an underlying other component. Each boss 24c is advantageously attained by injection overmolding of the said second composite.

The two brackets 24 of each pair are joined together by a transverse flat web 27 likewise overmolded, which stiffens these brackets 24. Each web 27 follows the transverse profile of the underside of the channel 17, covering the respective external faces of the top leg 24d of each bracket 24, of the flanges 25 and 26, of the base 14 and of the sidewalls 15 and 16 of the profile 12.

Advantageously, at least one of the end webs 27 of the profile 12 may be provided with a clamp 28 for attaching a member 29 such as a pipe or strand of cables that requires anchorage (this member 29 is shown in FIG. 6 secured to another element 30 of the bracket or rib type of a profile according to an alternative form of the invention), this clamp 28 preferably being overmolded at the same time as this web 27. Thus, the web 27 in FIGS. 3 and 4 and the bracket 30 in FIG. 6 each perform the dual function of stiffening (by the rib made up of the web 27 or of the bracket 30) and of supporting the clamp 28.

The profile 12 according to the invention and visible in FIGS. 3 and 4 also has longitudinal and transverse edges covered by overmolded longitudinal 31 (on the flanges 25 and 26) and transverse 32 (at least on the attachment 24) borders which are intended to conceal the visible fibers of said first composite and which are advantageously obtained by injection overmolding of said second composite.

FIG. 5 also illustrates the possible concealment of the fibers visible on the external surface of a bracket 24′ of another profile according to the invention, this bracket 24′ being stiffened by a rib 18′ by the injection overmolding of said second composite which then also covers edges 21 of this surface, and the creation through this injection overmolding of a support boss 22 on this surface for holding the profile 12 on another similar component.

It will be noted that the profile 12 incorporating these torsional and flexural stiffening cross braces 18 thus obtained is not only a structural element but also allows electrical and hydraulic systems to be attached once this profile 12 has been assembled on the support 3 via its attachment brackets 24 (see FIGS. 3 and 4).

The applicant company has carried out fundamental mode calculations on the crossmember 11 of FIG. 2 including this profile 12 with local stiffening cross braces 18 according to the invention, in comparison with the crossmember 1 of FIG. 1 that has a profile 2 that has no local stiffening cross brace 18.

The crossmember 11 with a profile 12 of FIG. 2 thus had a natural frequency of 23.25 Hz as compared with the natural frequency of 17.16 Hz of the crossmember 1 of FIG. 1, which is a frequency advantageously above the desired limit of 23 Hz in this example.

1. A profile comprising at least one portion of substantially U-shaped cross section which has a channel delimited by two sidewalls and a base connecting them together and which is locally provided with local stiffening means able to stiffen said at least one portion in torsion, the profile being made up of a fiber-reinforced plastic composite, said local stiffening means comprising at least one cross brace formed in said channel of one piece with the sidewalls and said base, wherein said sidewalls and said base are reinforced with fibers oriented predominantly in the longitudinal direction of the profile, with more than 60% of said fibers being oriented in a direction that makes an angle of between −30° and +30° with said longitudinal direction.

2. The profile as claimed in claim 1, wherein said at least one cross brace comprises at least two ribs providing torsional stiffening, which extend in planes substantially perpendicular to a plane of said base over substantially the entire height of said channel.

3. The profile as claimed in claim 2, wherein said ribs have a mutual intersection at a middle zone of said at least one cross brace which brace is substantially X-shaped having tips secured to said sidewalls.

4. The profile as claimed in claim 1, wherein said at least one portion has a plurality of said cross braces spaced apart longitudinally and also able to stiffen said at least one portion in flexion, said cross braces not being connected to one another.

5. The profile as claimed in claim 1, wherein the profile is made up of said composite which has a thermoplastic matrix, said at least one cross brace being formed of one piece with said at least one portion by overmolding, for example by two-shot injection molding, compression molding, welding or bonding.

6. The profile as claimed in claim 5, wherein said at least one portion is made up of a first composite with a thermoplastic matrix, said at least one cross brace being overmolded onto this portion and made up of a second composite with a thermoplastic matrix chemically compatible with the matrix of the first composite, both matrices preferably being chosen from the group consisting of polyphenylene sulfides (PPS), polyether ether ketones (PEEK), polyether ketone ketones (PEKK), polyamides (PA), polyether imides (PEI) and blends thereof.

7. The profile as claimed in claim 6, wherein said first composite is reinforced with said fibers which are oriented predominantly in the longitudinal direction of the profile and which are continuous fibers of alternatively long fibers several centimeters in length, so as to increase the flexural rigidity of the profile while minimizing the mass thereof.

8. The profile (12) as claimed in claim 6, wherein:
said first composite comprises a stack of sheets preimpregnated with said thermoplastic matrix and reinforced with carbon fabrics, this stack ending at an internal surface of said channel with a sheet based on this same matrix and filled with glass fabric(s), and in that
said second composite is reinforced with glass or carbon fibers, preferably short fibers.

9. The profile as claimed in claim 6, said second composite, which is overmolded onto said at least one portion, furthermore by this overmolding covers longitudinal and/or transverse edges of the profile so as to conceal fibers visible on said edges.

10. The profile as claimed in claim 1, wherein said profile is made up of a single said substantially U-shaped portion said sidewalls of which end substantially at right angles in two respective flanges extending away from one another, said flanges being provided with means of attachment to a support accepting the profile, so that this support and the profile sitting atop it form a crossmember of a grating able to support a fluid circuit and/or a wiring harness.

11. The profile as claimed in claim 10, wherein said means of attachment comprise pairs of brackets extending opposite each other from said flanges, the two brackets of each of said pairs being joined together by a transverse stiffening web, which stiffens said brackets.

12. The profile as claimed in claim 11, wherein at least one of said transverse stiffening webs supports a clamp for attaching a member, said clamp being overmolded as one piece with the web that supports it.

13. The profile as claimed in claim 6 said second composite which is overmolded over said at least one portion also through this overmolding forms support zones such as bosses under said means of attachment of the profile, these support zones being able to hold the profile on another similar component.

14. A load-bearing structural element of a vehicle, this element being for example a longitudinal member, a crossmember, a structural stiffener or a grating able to support a fluid circuit and/or a wiring harness and comprising longitudinal members and crossmembers, wherein said element comprises a profile as defined in claim 1.

15. A method of manufacturing a profile as claimed in claim 1, wherein the method involves securing said at least one cross brace to said at least one substantially U-shaped portion by overmolding, molding, welding or bonding.

16. The method as claimed in claim 15, wherein said profile is made up of said composite which has a thermoplastic matrix, said at least one cross brace being formed of one piece with said at least one portion by overmolding, two-shot injection molding, compression molding, welding or bonding, and wherein said at least one substantially U-shaped portion being fashioned by stamping or by compression molding, and said at least one cross brace being secured to this portion by overmolding, for example by two-shot injection molding or by compression molding.
